(19) United States
(12) Patent Application Publication
(10) Pub. No.: US 2011/0161240 A1
(43) Pub. Date: Jun. 30, 2011

(54) TRANSPORTATION MONITORING DEVICE AND METHOD THEREOF

(75) Inventors: KUNG-CHIEH CHENG, Tu-Cheng (TW); CHIH-CHUN LEE, Tu-Cheng (TW); FU-QIANG HE, Shenzhen City (CN); GUANG-TAO JIANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/915,040

(22) Filed: Oct. 29, 2010

(30) Foreign Application Priority Data
Dec. 28, 2009 (CN) 200910312402.4

(51) Int. Cl. G06Q 30/00

(52) U.S. Cl. 705/333

(57) ABSTRACT

A transportation monitoring method is provided for monitoring the transportation process of a vehicle from shipment place to a destination. The method comprising: receiving a shipment information from the shipment place when the vehicle leaves the shipment place; receiving arrival information from the destination when the vehicle arrives to the destination; determining whether the arrival information of the vehicle is received at least one predetermined time; generating a notice to associated administrators of the at least one predetermined time if the arrival information of the vehicle is not received.

### BACKGROUND

1. Technical Field

The present disclosure relates to a transportation monitoring device and a method thereof.

2. Description of Related Art

Transportation monitoring systems provide benefit to better manage logistics operations. These systems provide shipping information and arrival information of goods. However, these systems cannot monitor a process of a vehicle from a place of shipment to a place of destination. If the vehicle does not arrive at the place of destination on time, logistics management cannot obtain the information about that the vehicle has not arrive and where the vehicle is in time.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram showing a transportation process of a vehicle from a shipment place to a destination using a transportation monitoring device, in accordance with an exemplary embodiment.

FIG. 2 is a block diagram of the transportation monitoring device of FIG. 1 in accordance with an exemplary embodiment.

FIG. 3 is a schematic diagram of a warning table stored in data storage of the transportation monitoring device of FIG. 2.

FIG. 4 is a flowchart of a method for monitoring a transportation process of a vehicle employed by the transportation monitoring device, in accordance with an exemplary embodiment.

### DETAILED DESCRIPTION

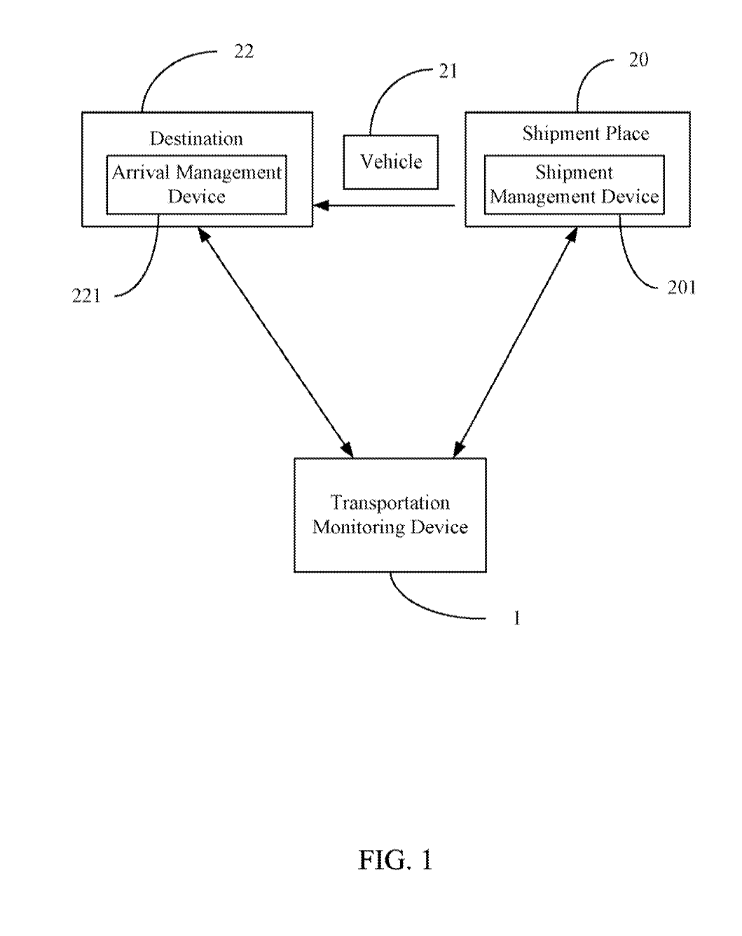

Referring to FIG. 1, a transportation monitoring device 1 is provided for monitoring the transportation process of a vehicle 21 from shipment place 20, where the vehicle 21 starts off, to a destination 22 where the vehicle 22 arrives.

When the vehicle 21 starts off from shipment 20, a shipment management device 201 is set on the shipment 20, generates shipment information of the vehicle 21 and sends the shipment information to the transportation monitoring device 1. The shipment information includes a vehicle ID, a time when the vehicle leaves the shipment place 20, and a due time when the vehicle 21 is scheduled to arrive at the destination 22. Each vehicle 21 is assigned one or more administrators at a predetermined time. In one embodiment, the number of predetermined times are set during the transportation process of a vehicle 1, the first predetermined time is the due time of the vehicle 1, and other predetermined times are set based on the first predetermined time. That is, other predetermined times are set after the first predetermined time. The transportation monitoring device 1 provides a warning table to each vehicle 21 for recording the relationship between the predetermined times and the administrators of the vehicle 21 of the predetermined times. When the time reaches the predetermined time, the transportation monitoring device 1 determines whether the vehicle 21 has arrived at the destination 22. If the vehicle 21 has not arrived at the destination 22, the transportation monitoring device 1 sends a notice to corresponding administrators.

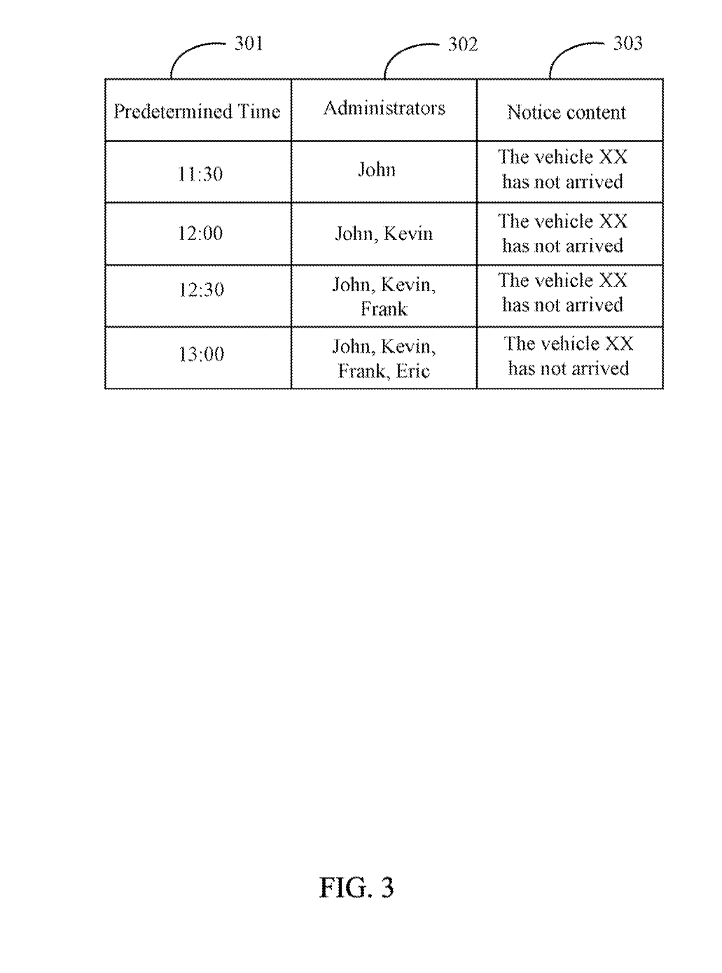

As shown in FIG. 3, the warning table includes a predetermined time column 301, an administrator column 302, and a warning content column 303. The predetermined time column 301 records the predetermined times. In this embodiment, four predetermined times are provided. The first predetermined time is the due time of the vehicle 21. The second, third, and fourth predetermined times are half hour after the previous predetermined time. The number of the predetermined times and values of the predetermined times can be predetermined by user. The warning content column 303 records the content of the warning sent to the corresponding administrators.

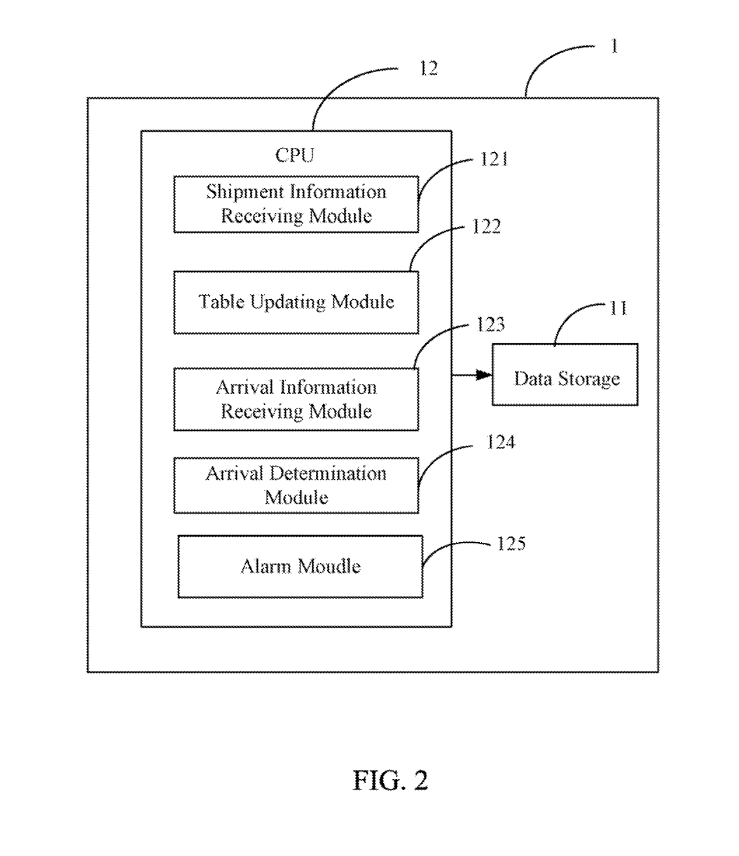

FIG. 2 is a block diagram of the transportation monitoring device 1 in accordance with an exemplary embodiment. The transportation monitoring device 1 includes a data storage 11 and a CPU 12. The data storage 11 stores the warning table. The CPU 12 includes a shipment information receiving module 121, a table updating module 122, an arrival information receiving module 123, an arrival determination module 124, and an alarm module 125.

The shipment information receiving module 121 receives the shipment information from the shipment management device 211 when the vehicle 21 leaves the shipment place 21.

The table updating module 122 obtains a corresponding warning table of the vehicle 21 according to the received vehicle ID and updates the predetermined times recorded in the warning table according to the received due time.

When the vehicle 21 arrives at the destination 22, the arrival management device 221 sends arrival information to the transportation monitoring device 1. The arrival information includes the vehicle ID and a real arrival time.

The arrival information receiving module 123 receives the arrival information from the destination 22.

The arrival determination module 124 obtains a corresponding warning table of the vehicle 21 according to the vehicle ID received by the shipment information receiving module 121. When the current time reaches to the predetermined time recorded in the warning table, the arrival determination module 124 determines whether the arrival information receiving module 123 receives the arrival information of the vehicle 21. The alarm module 125 generates a message that the vehicle 21 has arrived at the destination 22 to the corresponding administrators if the arrival information receiving module 122 receives the arrival information of the vehicle 21. The alarm module 125 sends the corresponding notice of the current predetermined time recorded in the notice content column 303 to the corresponding administrators if the arrival information receiving module 122 does not receive the arrival information of the vehicle 21. After the corresponding notice of the current predetermined time recorded in the notice content column 303 is sent to the corresponding administrators, the arrival determination module 124 determines whether the current predetermined time is the last predetermined time recorded in the warning table. If the current predetermined time is the last predetermined time recorded in the warning table, the arrival determination module 124 stops.

In the exemplary embodiment, a Globe Positioning System (GPS) is set on the vehicle 21 for providing the current position information of the vehicle 21. When the arrival determination module 124 determines that the vehicle 21 does not arrive at the destination 22 at the predetermined time, the alarm module obtains the current position information from the GPS of the vehicle 21 and sends the current position information of the vehicle 21 to corresponding administrators.

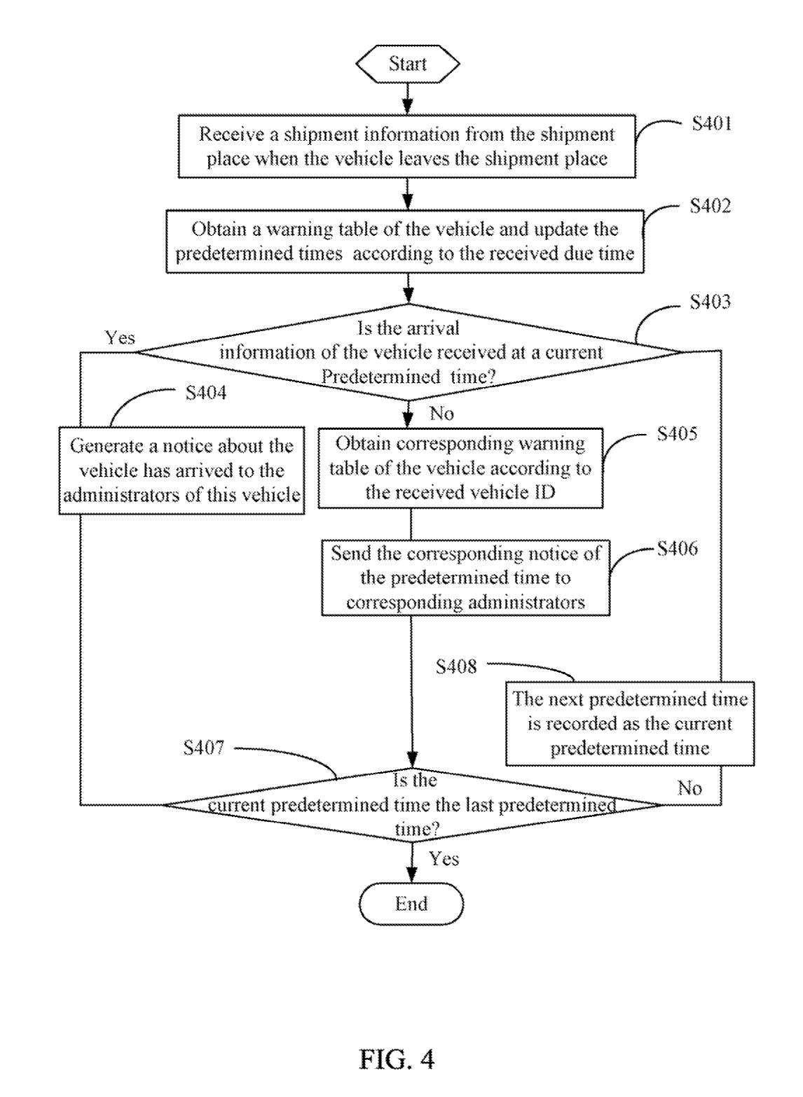

FIG. 4 is a flowchart of a method for monitoring the transportation of the vehicle.

In step S401, the shipment information receiving module 121 receives the shipment information from the shipment place 21 when the vehicle 21 leaves the shipment place 21.

In step S402, the table updating module 122 obtains corresponding warning table of the vehicle 21 according to the received vehicle ID and updates the predetermined times recorded in the warning table according to the received due time.

In step S403, when the time reaches the current predetermined time recorded in the warning table, the arrival determination module 124 determines whether the arrival information receiving module 123 receives the arrival information of the vehicle 21 at a the current predetermined time.

In step S404, if the arrival information receiving module 122 receives the arrival information of the vehicle 21 at the current predetermined time, the alarm module 125 generates a notice that the vehicle has arrived to the related administrators of this vehicle 21.

If the arrival information receiving module 123 does not receive the arrival information of the vehicle 21 at the predetermined time, in step S405, the arrival determination module 124 obtains corresponding warning table of the vehicle 21 according to the received vehicle ID.

In step S406, the alarm module 125 sends the corresponding notice of the current predetermined time recorded in the notice content column 305 to corresponding administrators.

In step S407, the arrival determination module 124 determines whether the predetermined time is the last predetermined time. If the predetermined time is the last predetermined time, the procedure ends.

If the predetermined time is not the last predetermined time, in step S408, the next predetermined time of the current predetermined time recorded in the warning table is recorded as the current predetermined time, and then the procedure goes to step S403.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A transportation monitoring device for monitoring a transportation process of a vehicle from a shipment place to a destination process, comprising:
a data storage for storing a warning table to each vehicle for recording the relationship between the predetermined times and the administrators of the vehicle of the predetermined times;
a shipment information receiving module for receiving a shipment information from the shipment place when the vehicle leaves the shipment place;
a table updating module for obtaining corresponding warning table of the vehicle and updates the predetermined times recorded in the warning table according to the received shipment information;
an arrival information receiving module for receiving arrival information from the destination when the vehicle arrives to the destination;
an arrival determination module for determining whether the arrival information receiving module receives the arrival information of the vehicle at the at least one predetermined time;
an alarm module for generating a notice to associated administrators of the at least one predetermined time if the arrival information receiving module does not receive the arrival information of the vehicle.

2. The transportation monitoring device as described in claim 1, wherein the shipment information comprises a vehicle ID, a leaving time when the vehicle leaves the shipment place, and a due time, the due time is the time when the vehicle is appointed to arrive at the destination.

3. The transportation monitoring device as described in claim 2, wherein the due time is the time when the vehicle is appointed to arrive at the destination, a number of predetermined times are set during a transportation process of a vehicle, the first predetermined time is the due time of the vehicle, and other predetermined times are set based on the first predetermined time, the first predetermined time is the due time of vehicle and the other predetermined times is predetermined according to the due time.

4. The transportation monitoring device as described in claim 1, wherein a warning table is store in the data storage for recording the relationship between the predetermined times and the administrators of the vehicle in the predetermined times.

5. The transportation monitoring device as described in claim 1, when the vehicle arrives at the destination, an arrival management device set at the destination sends arrival information to the transportation monitoring device, the arrival information includes a vehicle ID, and an real arrival time.

6. The transportation monitoring device as described in claim 1, wherein a Globe Positioning System (GPS) is set on the vehicle for providing the current position information of the vehicle, when the arrival determination module determines that the vehicle does not arrive at the destination at the predetermined times, the alarm module obtains the current position information from the GPS of the vehicle and sends the current position information of the vehicle to corresponding administrators of the predetermined time.

7. A transportation monitoring method for monitoring a transportation process of a vehicle from a shipment place to a destination process, comprising:
providing a warning table to each vehicle for recording the relationship between the predetermined times and the administrators of the vehicle of the predetermined times
receiving a shipment information from the shipment place when the vehicle leaves the shipment place;
obtaining corresponding warning table of the vehicle and updates the predetermined times recorded in the warning table according to the received shipment information;
determining whether an arrival information of the vehicle is received at least one predetermined time;
generating a notice to associated administrators of the at least one predetermined time if the arrival information of the vehicle is not received.

8. The transportation monitoring method as described in claim 7, wherein the shipment information comprises a vehicle ID, a leaving time when the vehicle leaves the shipment place, and a due time, the due time is the time when the vehicle is appointed to arrive at the destination.

9. The transportation monitoring method as described in claim 8, wherein the due time is the time when the vehicle is appointed to arrive at the destination, a number of predetermined times are set during a transportation process of a vehicle, the first predetermined time is the due time of the vehicle, and other predetermined times are set based on the first predetermined time, the first predetermined time is the due time of vehicle and the other predetermined times is predetermined according to the due time.

10. The transportation monitoring method as described in claim 8, when the vehicle arrives at the destination, an arrival management device set at the destination sends arrival information to the transportation monitoring device, the arrival information includes a vehicle ID, and an real arrival time.
